(19) United States
(12) Patent Application Publication
(10) Pub. No.: US 2008/0264652 A1
(43) Pub. Date: Oct. 30, 2008

(54) Safety System in a Motor Vehicle

(75) Inventors: Gian Luca Baccelli, Taunusstein-Orlen (DE); Fries Armin-Lutz, Nurnberg (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 11/997,085

(22) PCT Filed: Jul. 11, 2006
(86) PCT No.: PCT/EP2006/006752

§ 371 Date: Jul. 16, 2008

(30) Foreign Application Priority Data
Aug. 1, 2005 (DE) 10 2005 035 994.9

(51) Int. Cl. A62C 3/07

(52) U.S. Cl. 169/62

(57) ABSTRACT

A safety system in a motor vehicle is disposed in an engine compartment closable by means of a flap member. In order to increase the passive safety of the motor vehicle, containers filled with an extinguishing medium are disposed on an inner side of the engine compartment and, in the event of a limit temperature being exceeded, release the extinguishing medium.

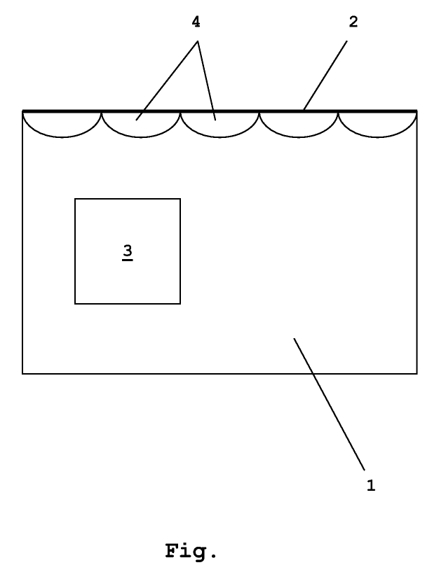

### CROSS-REFERENCE TO RELATED APPLICATIONS

This application is a U.S. National-Stage entry under 35 U.S.C. § 371 based on International Application No. PCT/EP2005/006752, filed Jul. 11, 2006, which was published under PCT Article 21(2) and which claims priority to German Application No. DE 10 2005 035 994.9, filed Aug. 1, 2005.

### TECHNICAL FIELD

The invention generally refers to a safety system, and more particularly refers to a safety system in a motor vehicle having an engine compartment closable by means of a flap member.

### BACKGROUND

From automotive engineering practice it is known that despite modern passive safety systems and through the use of non-combustible or at least fire-retardant materials in motor vehicle construction it is not possible to completely rule out the occurrence of a fire, particularly in an engine compartment of the motor vehicle. Such a fire may be caused i.a. by a leak in the fuel line, from which combustible fuel, such as petrol, may escape and self-ignite on hot parts of the engine. Furthermore in the event of an accident, for example, a fuel line or a fuel tank itself may develop a leak and allow an escape of fuel that may likewise lead to a fire.

In order to be able to extinguish a fire that has broken out in this way, a portable fire extinguisher is often carried in the motor vehicle and is used by a driver or some other person to extinguish the fire. In such a situation, however, shock or inexperience often leads to incorrect operation of the fire extinguisher or to inappropriate action being taken to combat an outbreak of fire, the result frequently being a total loss of the motor vehicle. The fire may also place other road users at risk.

DE 103 33 382 A1 describes a device for fighting a fire particularly in a commercial vehicle, which conventionally has a pneumatically operated brake system. Here, an extinguishing liquid stored in a reservoir is distributed with the aid of the operating compressed air contained in one or more compressed-air tanks in the motor vehicle by means of devices known per se, for example in the engine compartment of the motor vehicle in order in this way to fight an outbreak of fire. Here, however, the situation may arise that, for example as a result of an accident, the compressed-air tank itself may be damaged and consequently the extinguishing medium can no longer be delivered with the aid of compressed air.

DE 90 12 180 U1 discloses a control unit for fire-extinguishing systems in motor vehicles comprising a three-way switch in order to be able to check the operating capability of the entire fire-extinguishing system in a motor vehicle with the aid of a testing mode.

DE 87 15 208 U1 discloses an installation kit for a fire-extinguishing device for motor vehicles comprising an extinguishing medium container, connection lines leading to spray nozzles, for example in an engine compartment of the motor vehicle, as well as valves associated with the spray nozzles for opening the lines. The installation kit is installed in a motor vehicle, wherein the spray nozzles are disposed in the engine compartment so that they may be used to fight an outbreak of fire.

The drawback of these active systems is that they always entail a large number of mechanical and electrical components in order for example to be able automatically to detect an outbreak of fire and take appropriate countermeasures. These components however may themselves fail in the event of an accident, thereby preventing effective fire fighting.

The object of the invention is to indicate a safety system in a motor vehicle of the initially described type, with which an outbreak of fire in the engine compartment of the motor vehicle may be reliably brought under control.

### SUMMARY

According to the invention, the object is achieved in that containers filled with an extinguishing medium are disposed on an inner side of the engine compartment and, in the event of a limit temperature being exceeded, release the extinguishing medium.

The basic idea of the invention is to use a passively effective system for fire fighting. This system substantially comprises one or more containers that are filled with any desired extinguishing medium, for example a liquid, a gas, or a gel as described below. In this case, the containers and/or their walls are designed in such a way that, in the event of a limit temperature being exceeded, as necessarily occurs in the event of an outbreak of fire in the engine compartment of the motor vehicle, the extinguishing medium is released. For this purpose, the walls of the containers are made for example of a material that, in the event of the limit temperature being exceeded, melts open and thereby allows a liquid, gas or gel to escape from the containers.

In this case, it also lies within the scope of the invention to dispose one or more containers in the engine compartment of the motor vehicle, wherein their respective shape, number and size may be selected by the person skilled in the art in dependence upon the extinguishing medium needed to extinguish a fire and upon the dimensions of the engine compartment and/or engine.

As containers, preferred use is made of hollow spherical formed bodies that are filled with an extinguishing gel, wherein the containers are designed preferably in the form of spherical wax receptacles that melt open in the event of an outbreak of fire. In this case, the extinguishing gel is designed in such a way that, on the one hand, it contains water for removing heat from the seat of the fire through evaporation of the water and, on the other hand, the extinguishing gel contains foam-forming substances, which for example drip onto an engine block and form an airtight foam layer on the hot metal of the engine block that isolates the engine block from the ambient atmospheric oxygen. The extinguishing gel moreover preferably contains saponification agents, for example in the form of alkaline substances, which with the carbon fractions in the lubricating oil and/or in the fuel jointly with the water contained in the extinguishing gel enter into an endothermic reaction and saponify the hydrocarbons, so that further supplies and heat are removed from the seat of the fire.

The advantage of the invention lies in the fact that no electrical or mechanical components whatsoever are needed to trigger the safety system so that, even in the event of total failure of the vehicle electronic system, an outbreak of fire in the engine compartment of the motor vehicle may be reliably brought under control by the automatic release of the extinguishing medium from the containers disposed in the engine compartment.

The containers are advantageously of a spherical and/or cushion-shaped design and are arranged preferably distributed over the entire surface of the interior of the engine compartment of the vehicle. In this case, more containers and/or containers of greater volumes may be disposed at particular trouble spots, for example directly above the engine block.

In an advantageous development, the inside and/or underside of a bonnet of the motor vehicle is provided with such containers. In this case, these containers may replace the otherwise provided sound insulation materials.

To achieve a further increase in the safety of the motor vehicle, preferably in addition to the passive system an active safety system, known per se, is provided, which substantially comprises an extinguishing medium reservoir, devices for distributing the extinguishing medium, sensors for detecting a fire and a control unit. In the extinguishing medium reservoir solid, liquid or gaseous extinguishing media may be stored, for example powder or CO2. The extinguishing medium is preferably released by means of pumps through lines as well as nozzles and optionally valves associated with the nozzles at locations suitable for this purpose in the engine compartment of the motor vehicle, in order in this way to extinguish a fire. By means of the sensors an outbreak of fire or an already existing fire may be detected and a corresponding signal relayed to a control unit of the safety system, for example via data bus architectures, known per se. In this case, the control unit may also be integrated in a central control device for controlling every function of the motor vehicle.

The sensors for detecting a fire may be temperature- and/or crash- and/or airbag sensors. Temperature sensors detect a raised temperature in the engine compartment using any desired measuring principles, crash sensors detect for example a deformation of a body of the motor vehicle, and an airbag sensor detects deployment of the airbag. In this case, from the corresponding signals the control unit concludes that a fire may break out or has already broken out and takes corresponding countermeasures.

It is moreover possible for the active safety system, for example in dependence upon only a slow rise of temperature, to take only gradual countermeasures, such as for example the release of extinguishing media only in a limited region of the engine compartment or only a small quantity of the extinguishing medium.

In a preferred form of construction, the active safety system also comprises a fuel cut-off device to stop the supply of further fuel from the fuel tank into the engine compartment. Such a cut-off device may for example take the form of a solenoid valve, which is likewise connected to the control unit.

In case the control unit should fail as a result of damage, the safety system is also provided with a manual triggering device so that the safety system may be triggered for example by the operation of a switch on the instrument panel by an occupant of the motor vehicle. Analogously, a corresponding actuating device may be provided on an outer side of the body of the motor vehicle, for example in the region of the A pillar, in order to allow rescue forces to trigger the safety system.

In the above the active system was described in connection with a passive safety system. It is however obvious to the person skilled in the art that the active safety system may also be installed on its own in a motor vehicle.

It is self-evident that the features described above and yet to be described below may be used not only in the combination indicated in each case but also in other combinations. The scope of the invention is defined only by the claims.

### BRIEF DESCRIPTION OF THE DRAWINGS

The present invention will hereinafter be described in conjunction with the following drawing figures, wherein like numerals denote like elements, and

The single FIGURE of the drawing shows in a schematic representation an engine compartment of a motor vehicle in cross section, but for the sake of simplicity without the actual engine.

### DETAILED DESCRIPTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The engine compartment 1 is closable by means of a flap member 2 in the form of a bonnet, wherein the bonnet is opened in order, for example, to be able to carry out an engine inspection. In the engine compartment 1 there is an active safety system 3, known per se, which comprises i.a. an extinguishing medium reservoir, devices for distributing the extinguishing medium, sensors for detecting a fire and a control unit, wherein the corresponding components are known in the prior art and their arrangement in the engine compartment or at any other suitable point in the motor vehicle is possible for the person skilled in the art. In this case, the control unit is designed in such a way that, for example in dependence upon a signal of a temperature- or crash sensor, it activates a pump for delivering extinguishing medium from the extinguishing medium reservoir through connection lines to outlet nozzles in the engine compartment 1 in order in this way to fight an outbreak of fire.

As a passive safety system a plurality of spherical or, as shown here, cushion-shaped containers 4 for an extinguishing medium are disposed, for example fixedly adhered, on the inside and/or underside of the flap member 2, wherein the walls of the containers 4 are designed in such a way that, in the event of a limit temperature being exceeded in the manner typical of an outbreak of fire in the engine compartment 1 of the motor vehicle, the walls release the extinguishing medium. For example, the walls of the containers 4 may be made of a suitable wax-like material, which, in the event of the temperature being exceeded, melts open in order thereby to release the extinguishing medium, for example a gel, liquid or gas. In this case, the extinguishing gel is in particular designed in such a way that the fire is fought both physically and chemically.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. A safety system in a motor vehicle having an engine compartment closable by means of a flap member, wherein containers filled with an extinguishing medium are disposed on an inner side of the engine compartment and, in the event of a limit temperature being exceeded, release the extinguishing medium.

2. The safety system according to claim 1, wherein the containers are spherical or cushion-shaped.

3. The safety system according to claim 1, wherein the containers are disposed on an inner side of a bonnet.

4. The safety system according to claim 1, further comprising an active safety system, which comprises an extinguishing medium reservoir, a device for distributing an extinguishing medium, sensors for detecting a fire and a control unit.

5. The safety system according to claim 4, wherein the sensors are temperature sensors.

6. The safety system according to claim 4, wherein by means of the active safety system different extinguishing intensities or distributions may be implemented.

7. The safety system according to claim 4, further comprising a fuel cut-off device.

8. Safety system according to claim 4, wherein a manual triggering device is provided, in particular on an outer side of the motor vehicle.

9. The safety system according to claim 4, wherein the sensors are crash sensors.

10. The safety system according to claim 4, wherein the sensors are air bag sensors.
